(19) United States
(12) Patent Application Publication
(10) Pub. No.: US 2026/0331801 A1
(43) Pub. Date: Oct. 22, 2026

(54) BOARD CONNECTOR

(71) Applicant: Yazaki Corporation, Tokyo (JP)

(72) Inventor: Hikaru ANMA, Shizuoka (JP)

(73) Assignee: Yazaki Corporation, Tokyo (JP)

(21) Appl. No.: 19/468,539

(22) Filed: Feb. 3, 2026

(30) Foreign Application Priority Data
Feb. 19, 2025 (JP) 2025-025113

(51) Int. Cl. H01R 12/71

(52) U.S. Cl. CPC H01R 12/716

(57) ABSTRACT

A board connector includes an inner terminal, an inner housing, an outer terminal, an outer housing, and a fixing member. The outer terminal includes a tubular portion and a connection portion that is electrically connected to a circuit board. The connection portion is connected to the tubular portion via a step portion, and is arranged radially outward of the tubular portion. The outer housing includes a rotation prevention portion that suppresses rotation of the outer terminal by abutting against the connection portion of the outer terminal.

### CROSS-REFERENCE TO RELATED APPLICATIONS

The present application is based on, and claims priority from the prior Japanese Patent Application No. 2025-025113, filed on Feb. 19, 2025, the entire contents of which are incorporated herein by reference.

### TECHNICAL FIELD

The present disclosure relates to a board connector.

### BACKGROUND

In the related art, for example, there has been known a board connector that is installed on a circuit board. JP 2013-37928 A discloses a technique relating to a board connector including an inner conductor terminal that is a terminal fitting, a dielectric that includes a terminal holding portion into which the inner conductor terminal is press-fitted, and an outer conductor terminal that is provided so as to cover the dielectric on which the inner conductor terminal is mounted. The board connector is configured so that the inner conductor terminal and the outer conductor terminal are arranged in proximity to each other. According to such a configuration, the inner conductor terminal is reduced in size, and the inner conductor terminal and the outer conductor terminal are arranged in proximity to each other. Consequently, the board connector can be reduced in size.

### SUMMARY OF THE INVENTION

In such a board connector, when a distance between a connection portion of the outer conductor terminal (outer terminal) and a connection portion of the inner conductor terminal (inner terminal) is reduced, impedance cannot be adjusted, and there is a possibility that transmission performance becomes unstable.

An object of the present disclosure is to provide a board connector capable of stabilizing transmission performance by adjusting a distance between a connection portion of an outer terminal and a connection portion of an inner terminal.

A board connector according to an embodiment includes an inner terminal that is electrically connected to a circuit board, and contacts with a mating inner terminal of a mating connector, an inner housing that includes an accommodation portion accommodating the inner terminal, an outer terminal that covers a part of the inner terminal, is electrically connected to the circuit board, and contacts with a mating outer terminal of the mating connector, an outer housing that includes an accommodation hole portion accommodating the outer terminal, and a fixing member that fixes the outer housing to the circuit board. The outer terminal includes a tubular portion and a connection portion that is electrically connected to the circuit board. The connection portion is connected to the tubular portion via a step portion, and is arranged radially outward of the tubular portion. The outer housing includes a rotation prevention portion that suppresses rotation of the outer terminal by abutting against the connection portion of the outer terminal.

According to the above-mentioned configuration, it is possible to provide a board connector capable of stabilizing transmission performance by adjusting a distance between a connection portion of an outer terminal and a connection portion of an inner terminal.

### BRIEF DESCRIPTION OF DRAWINGS

FIG. 1 is a perspective view illustrating a state in which a board connector according to the present embodiment is mounted on a circuit board.

FIG. 2 is a schematic plan view of the board connector as viewed from a back surface side of the circuit board.

FIG. 3 is a perspective view of the board connector.

FIG. 4 is an exploded perspective view of the board connector.

FIG. 5 is a back view of the board connector as viewed from a rear side.

FIG. 6 is a cross-sectional view taken along the line A-A of FIG. 5.

FIG. 7 is a side view of an inner terminal.

FIG. 8 is a front view of an inner housing as viewed from a front side.

FIG. 9 is a cross-sectional view taken along the line B-B of FIG. 8.

FIG. 10 is a front view of an outer terminal as viewed from a front side.

FIG. 11 is a cross-sectional view taken along the line C-C of FIG. 10.

FIG. 12 is a front view of an outer housing as viewed from a front side.

FIG. 13 is a back view of the outer housing as viewed from a rear side.

FIG. 14 is a front view of a peg as viewed from a front side.

### DETAILED DESCRIPTION OF THE INVENTION

With reference to the drawings, a board connector according to the present embodiment is described below in detail. Note that the dimensional ratios in the drawings are exaggerated for explanatory purposes, and may differ from the actual ratios.

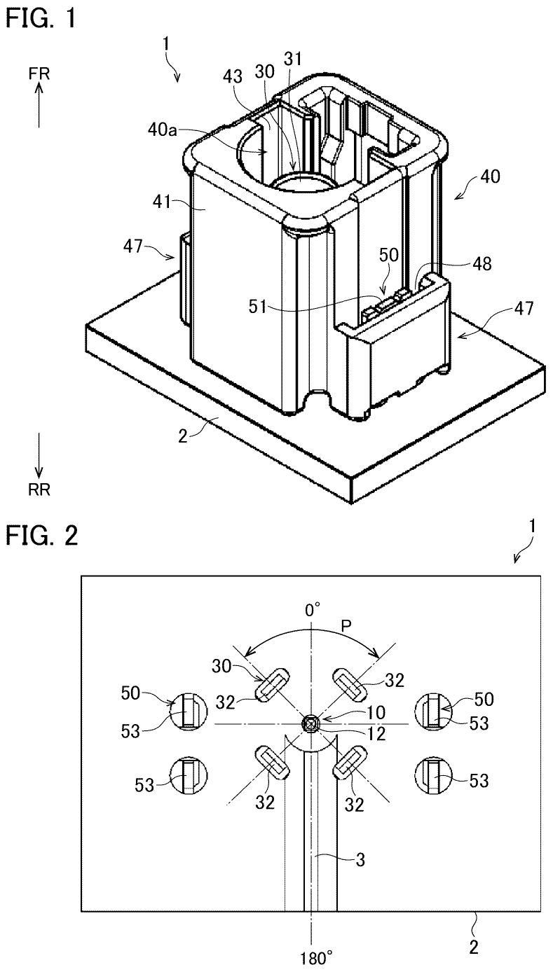

As illustrated in FIG. 1, a board connector 1 according to the present embodiment is a vertical male connector for high frequency use, which is also referred to as a printed circuit board (PCB) connector, and can be fitted into a mating connector (female connector) omitted in illustration.

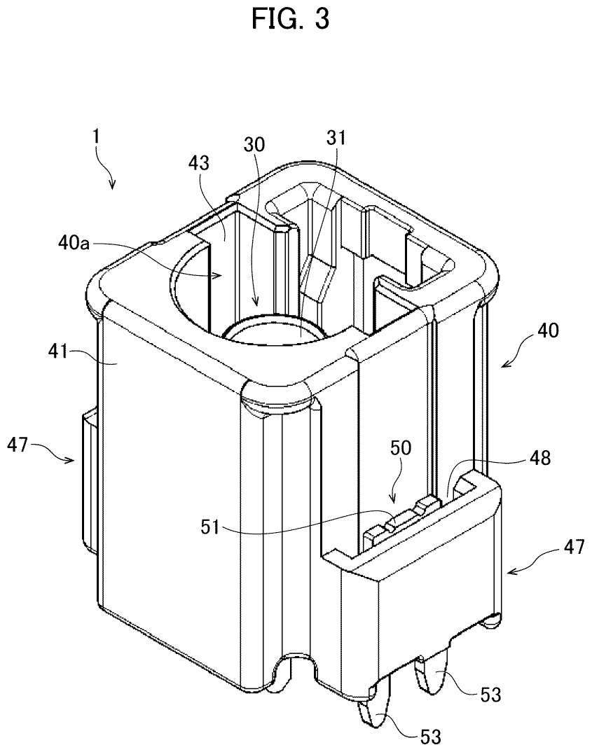

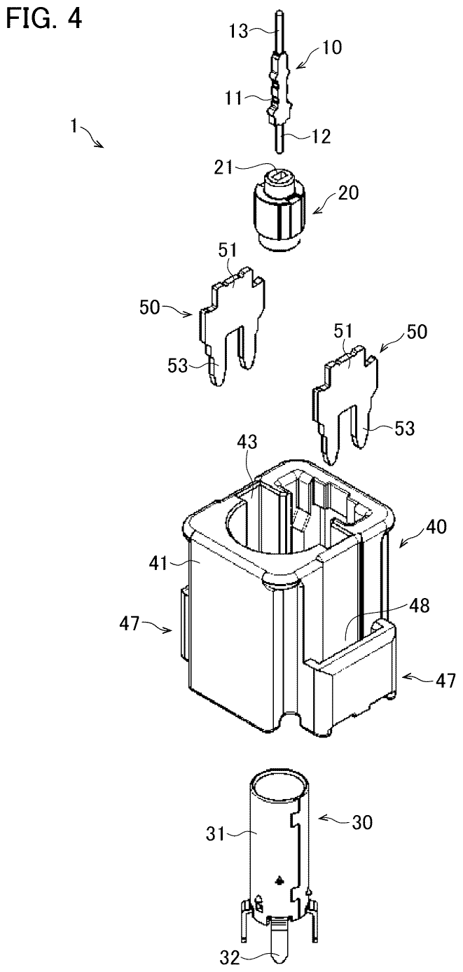

As illustrated in FIG. 1 to FIG. 6, the board connector 1 includes an inner terminal 10, an inner housing 20, an outer terminal 30, an outer housing 40, and a fixing member (peg 50). The board connector 1 is mounted on a circuit board 2 and used (see FIG. 1). In the present embodiment, an opening 40a side of the outer housing 40 is referred to as the front side FR, and the circuit board 2 side thereof is referred to as a rear side RR.

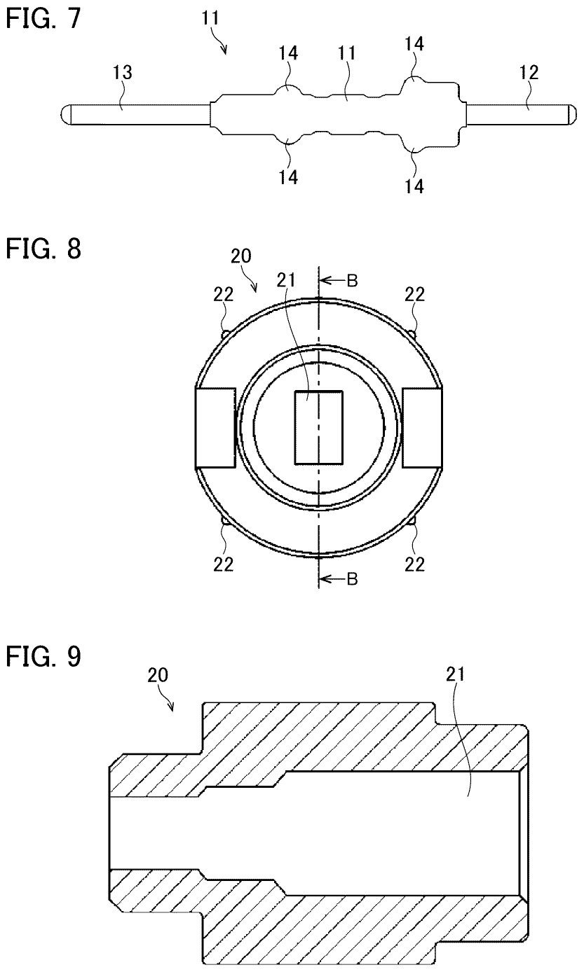

The inner terminal 10 illustrated in FIG. 7 is electrically connected to the circuit board 2, and contacts with a mating inner terminal of the mating connector (omitted in illustration). The inner terminal 10 is also referred to as an inner conductor. In the present embodiment, one inner terminal 10 is arranged, but a plurality of inner terminals may be arranged.

As illustrated in FIG. 7, the inner terminal 10 is formed into a bar-like shape of metal or the like, and includes a main body portion 11 and a connection portion 12. A distal end portion 13 of the main body portion 11 contacts with the mating inner terminal (omitted in illustration), and is conducted therewith. A press-fit protrusion 14 is formed at the main body portion 11. A plurality of (four in the present embodiment) press-fit protrusions 14 are formed at the main body portion 11, and are provided so that the inner terminal 10 is press-fitted into an accommodation portion 21 of the inner housing 20. The connection portion 12 extends from a rear end portion of the main body portion 11 toward the rear side RR. The connection portion 12 contacts with the circuit board 2, and is conducted therewith. The connection portion 12 is inserted into a through hole formed in the circuit board 2, and is fixed thereto via solder (see FIG. 2).

The inner housing 20 illustrated in FIG. 8 and FIG. 9 includes the accommodation portion 21 that accommodates the inner terminal 10. One accommodation portion 21 is arranged.

As illustrated in FIG. 8 and FIG. 9, the inner housing 20 is formed into a tubular shape of a synthetic resin or the like, and includes the accommodation portion 21 and a cylindrical projection portion 22. The accommodation portion 21 accommodates the inner terminal 10. The cylindrical projection portion 22 is formed on an outer periphery of the accommodation portion 21, and is provided so that the inner housing 20 is press-fitted and accommodated inside the outer terminal 30 having a tubular shape. In the present embodiment, a plurality of (four in the present embodiment) cylindrical projection portions 22 are provided at an interval in a circumferential direction.

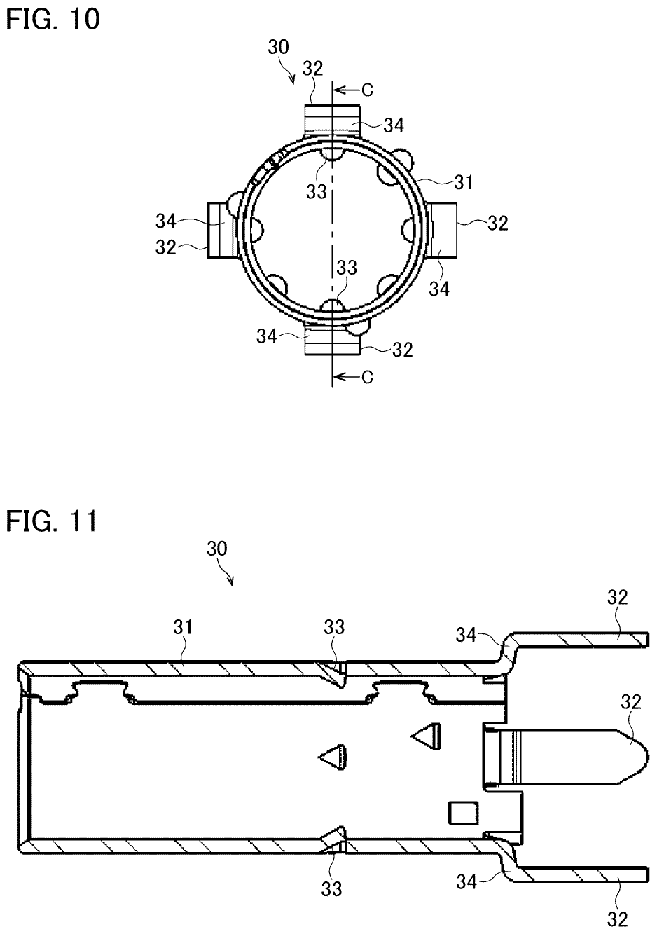

The outer terminal 30 illustrated in FIG. 10 and FIG. 11 covers a part of the inner terminal 10, is electrically connected to the circuit board 2, and contacts with a mating outer terminal of the mating connector (omitted in illustration). The outer terminal 30 is also referred to as an outer conductor. One outer terminal 30 is arranged.

As illustrated in FIG. 10 and FIG. 11, the outer terminal 30 is formed of metal or the like, and includes a tubular portion 31 and a connection portion 32. The tubular portion 31 is formed into a cylindrical shape, and abuts against a cylindrical projection portion 44 of the outer housing 40. The tubular portion 31 is a portion that contacts with the mating outer terminal (omitted in illustration), and is a portion in which the inner housing 20 is accommodated. A plurality of locking portions 33 formed by cutting and raising are formed at the tubular portion 31. The locking portions 33 lock the inner housing 20. The connection portion 32 contacts with the circuit board 2, and is conducted therewith. The connection portion 32 is connected to the tubular portion 31 via a step portion 34, and is arranged radially outward of the tubular portion 31 (see FIG. 11). The connection portion 32 is inserted into a through hole formed in the circuit board 2, and is fixed thereto via solder (see FIG. 2). In the present embodiment, a plurality of (four in the present embodiment) connection portions 32 are formed at an interval in the circumferential direction.

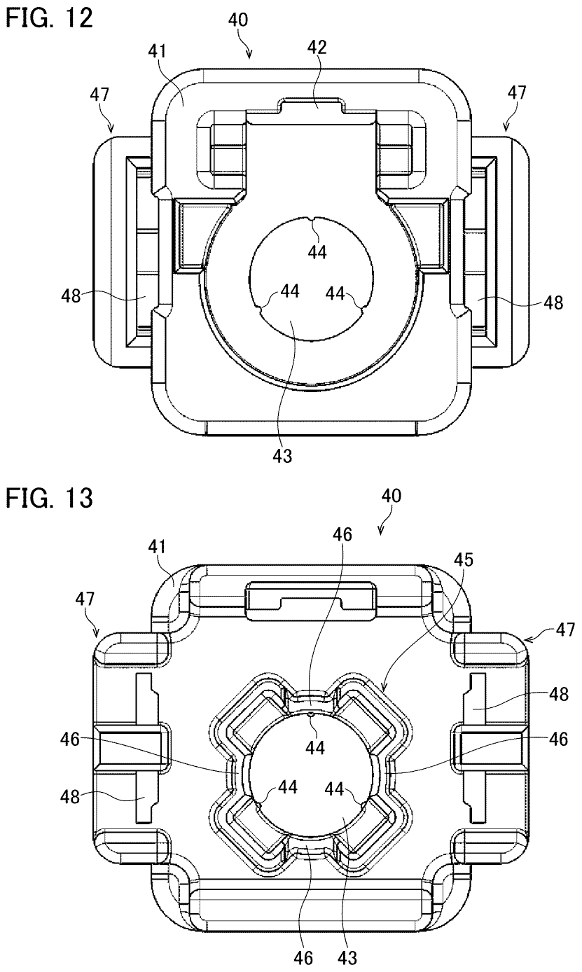

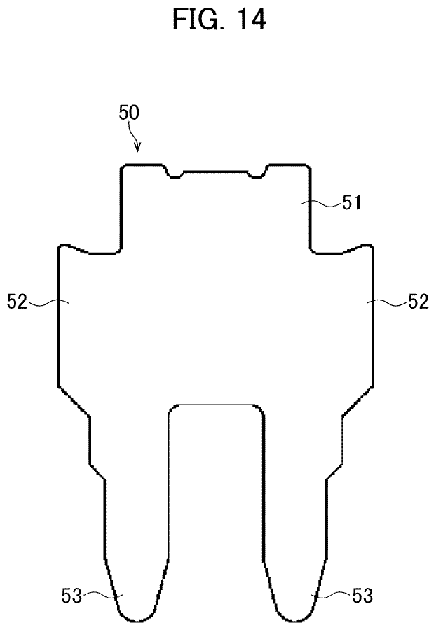

The outer housing 40 illustrated in FIG. 12 and FIG. 13 includes an accommodation hole portion 43 that accommodates the outer terminal 30.

As illustrated in FIG. 12 and FIG. 13, the outer housing 40 includes a main body portion 41 formed into a tubular shape of a synthetic resin or the like. A lock beak 42 that locks the mating connector (omitted in illustration) is formed at an upper part of the main body portion 41. The accommodation hole portion 43 for assembling the outer terminal 30 is formed inside the main body portion 41, and the cylindrical projection portion 44 against which the outer terminal 30 abuts is formed on an inner periphery of the accommodation hole portion 43. Further, at an end portion of the main body portion 41 on the rear side RR, a rotation prevention portion 45 that exerts a positioning function and a rotation prevention function with respect to the connection portion 32 of the outer terminal 30 is formed. The rotation prevention portion 45 includes a plurality of ribs 46 formed at an interval in the circumferential direction of the outer housing 40, and the connection portion 32 of the outer terminal 30 is arranged between those ribs 46. Further, a holding portion 47 that holds the peg 50 is formed on each of the right and left sides of the main body portion 41. The holding portion 47 includes a slit 48 extending along a direction in which the peg 50 is inserted.

The peg 50 illustrated in FIG. 14 fixes the outer housing 40 to the circuit board 2.

As illustrated in FIG. 14, the peg 50 includes a peg main body 51 that is formed into a plate-like shape of metal or the like. A press-fit protrusion 52 is formed on each of the right and left sides of the peg main body 51. The press-fit protrusion 52 is provided so that the peg 50 is press-fitted into and assembled to the holding portion 47 (slit 48) of the outer housing 40. At the peg main body 51, a connection portion 53 that extends downward from a lower end surface of the peg main body 51 is formed. The connection portion 53 contacts with the circuit board 2, and is conducted therewith. The connection portion 53 is inserted into a through hole formed in the circuit board 2, and is fixed thereto via solder (see FIG. 2).

When the distance between the outer conductor (the outer terminal 30) and the inner conductor (the inner terminal 10) is excessively reduced in the circuit board 2, impedance is affected, and transmission performance may not be stabilized. In the present embodiment, in order to stabilize transmission performance, the step portion 34 is formed between the tubular portion 31 and the connection portion 32 of the outer conductor (the outer terminal 30), and the distance between the connection portion 32 of the outer conductor (the outer terminal 30) and the connection portion 12 of the inner conductor (the inner terminal 10) is adjusted (see FIG. 6).

Further, as viewed from the back surface of the circuit board 2, the connection portions 32 of the outer terminal 30 are arranged at an equal interval P (at 90 degrees in the present embodiment) with a signal line 3 of the circuit board 2 as a reference so as to avoid a position of 0 degrees and a position of 180 degrees (see FIG. 2). By arranging the connection portions 32 of the outer terminal 30 in this manner, the connection portions 32 of the outer terminal 30 are prevented from overlapping with the signal line 3 of the circuit board 2. For example, this is because, when the connection portion 32 of the outer terminal 30 is arranged at a position of 0 degrees or a position of 180 degrees, arrangement of the signal line 3 may be complicated. In the present embodiment, in order to simplify arrangement of the signal line 3 of the circuit board 2, the connection portions 32 of the outer terminal 30 are arranged as illustrated in FIG. 2.

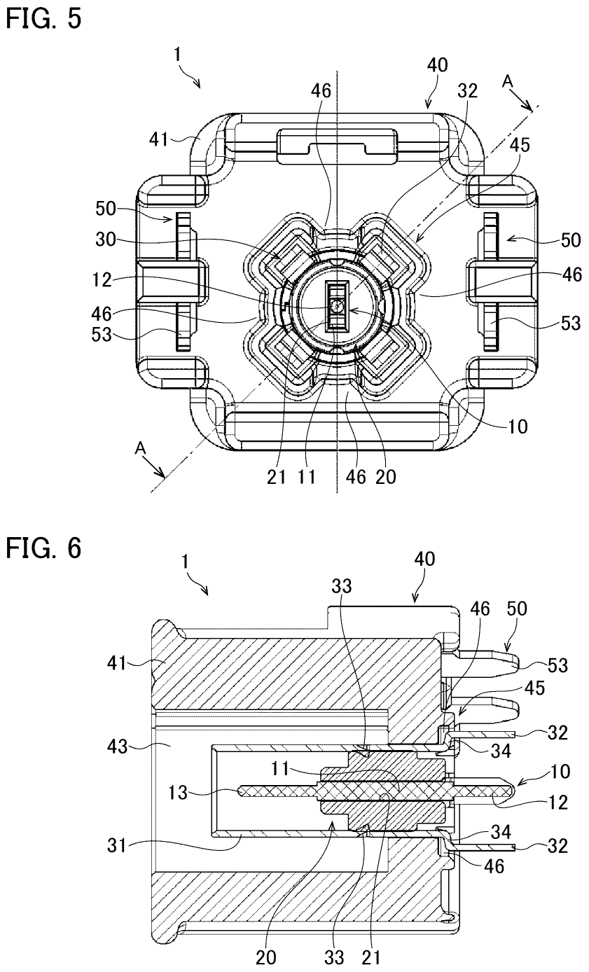

Further, when the board connector 1 is connected to the circuit board 2 without positioning the connection portion 32 of the outer terminal 30, the outer terminal 30 may rotate inside the outer housing 40. Thus, in the present embodiment, the rotation prevention portion 45 (ribs 46) is formed at the outer housing 40 so as to position the outer terminal 30 and restrict rotation of the outer terminal 30 (see FIG. 5 and FIG. 6).

As described above, the board connector 1 according to an aspect of the present embodiment includes the inner terminal 10 that is electrically connected to the circuit board 2 and contacts with the mating inner terminal of the mating connector, and the inner housing 20 that includes the accommodation portion 21 accommodating the inner terminal 10. The board connector 1 includes the outer terminal 30 that covers a part of the inner terminal 10, is electrically connected to the circuit board 2, and contacts with the mating outer terminal of the mating connector, and the outer housing 40 that includes the accommodation hole portion 43 accommodating the outer terminal 30. The board connector 1 includes the fixing member (peg 50) that fixes the outer housing 40 to the circuit board 2. The outer terminal 30 includes the tubular portion 31 and the connection portion 32 that is electrically connected to the circuit board 2, and the connection portion 32 is connected to the tubular portion 31 via the step portion 34, and is arranged radially outward of the tubular portion 31. The outer housing 40 includes the rotation prevention portion 45 that suppresses rotation of the outer terminal 30 by abutting against the connection portion 32 of the outer terminal 30.

The connection portion 32 of the outer terminal 30 is connected to the tubular portion 31 via the step portion 34, and is arranged radially outward of the tubular portion 31. With this, the distance between the outer terminal 30 and the inner terminal 10 can be adjusted so as to stabilize transmission performance. Further, the outer housing 40 includes the rotation prevention portion 45 that suppresses rotation of the outer terminal 30 by abutting against the connection portion 32 of the outer terminal 30. With this, work of assembling the outer terminal 30 to the circuit board 2 can be facilitated, and assembly workability can be improved.

According to the present embodiment described above, it is possible to provide the board connector 1 capable of stabilizing transmission performance by adjusting the distance between the connection portion 32 of the outer terminal 30 and the connection portion 12 of the inner terminal 10.

In the board connector 1, the rotation prevention portion 45 includes the plurality of ribs 46 that are formed at an interval in the circumferential direction of the outer housing 40.

Thus, the ribs 46 can perform positioning of the connection portion 32 of the outer terminal 30 and rotation prevention, work of assembling the outer terminal 30 to the circuit board 2 can be facilitated, and assembly workability can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A board connector comprising:
an inner terminal that is electrically connected to a circuit board, and contacts with a mating inner terminal of a mating connector;
an inner housing that includes an accommodation portion accommodating the inner terminal;
an outer terminal that covers a part of the inner terminal, is electrically connected to the circuit board, and contacts with a mating outer terminal of the mating connector;
an outer housing that includes an accommodation hole portion accommodating the outer terminal; and
a fixing member that fixes the outer housing to the circuit board, wherein the outer terminal includes a tubular portion and a connection portion that is electrically connected to the circuit board,
the connection portion is connected to the tubular portion via a step portion, and is arranged radially outward of the tubular portion, and
the outer housing includes a rotation prevention portion that suppresses rotation of the outer terminal by abutting against the connection portion of the outer terminal.

2. The board connector according to claim 1, wherein
the rotation prevention portion includes a plurality of ribs that are formed at an interval in a circumferential direction of the outer housing.
